(19) United States
(12) Patent Application Publication
(10) Pub. No.: US 2015/0254768 A1
(43) Pub. Date: Sep. 10, 2015

(54) METHODS AND SYSTEMS FOR LENDING MONEY

(71) Applicant: Artefacts Systems LLC, Alpharetta, GA (US)

(72) Inventors: Sandeep Sethumadhavan Menon, Alpharetta, GA (US); Rajil Vohra, Alpharetta, GA (US)

(73) Assignee: Artefacts Systems LLC, Alpharetta, GA (US)

(21) Appl. No.: 14/640,196

(22) Filed: Mar. 6, 2015

Related U.S. Application Data
(60) Provisional application No. 61/949,757, filed on Mar. 7, 2014.

(51) Int. Cl. G06Q 40/02; G06Q 20/34

(52) U.S. Cl. CPC G06Q 40/025; G06Q 20/342

(57) ABSTRACT

Methods and systems for providing short-term loans with instantaneous access to short-term working capital from float money generated out of a volume of prepaid/gift cards sold to the merchant's customers are described. A merchant takes out a short-term loan from a lender who opens both a Merchant Lending Account (“MLA”) and an Aggregated Balance Lending Account (“ABLA”) for the merchant. The value included within all prepaid accounts affiliated with merchant branded prepaid/gift cards are aggregated into the ABLA, and this balance may be used to close or restructure the original loan affiliated with the MLA.

### RELATED APPLICATION DATA

The present application claims priority to U.S. Provisional Patent Application No. 61/949,757, filed Mar. 7, 2014, which is incorporated herein by reference.

### FIELD OF THE TECHNOLOGY

The present disclosure relates generally to short-term lending and, more particularly, to short-term lending alternative payoff and restructuring sources.

### BACKGROUND

Merchants commonly have financial obligations that must be satisfied, such as employee payroll, structural improvements, and the like. Sometimes, a merchant is flush with enough liquid capital to satisfy its financial obligations. However, often, merchants run lean due to various constraints, resulting in the merchant not having sufficient liquid capital on hand to satisfy its financial obligations, and thereby causing the merchant to look elsewhere for financing.

When this occurs, the merchant often borrows needed capital from a third party lender. These loans are often paid back over the entire term of the loan. Nonetheless, this current structure of lending falls short of allowing the borrowing merchant to pay back the loan more expeditiously than is required under the loan term.

### SUMMARY

The present disclosure provides methods and systems that utilize merchant aggregate balance lending accounts, dependent upon reloadable prepaid/gift card values, to allow merchants to satisfy or restructure a loan prior to the expiration of the loan's term.

An aspect of the present disclosure relates to a method for allowing a merchant to utilize an aggregated balance lending account, which is dependent upon prepaid card account balances, to close or restructure a loan. The method includes receiving a short-term loan application from a merchant and originating the loan by conducting underwriting processes. The method further includes instructing a sponsor bank to open a merchant lending account and an aggregated balance lending account. The aggregated balance lending account has a balance equal to a sum of all prepaid account balances affiliated with merchant branded prepaid cards. Moreover, the method includes notifying the merchant of closing and restructuring options when the aggregated balance lending account reaches a threshold.

The merchant lending account has a balance equal to an outstanding loan repayment amount. Furthermore, the aggregated balance lending account decreases when a prepaid card is redeemed and increases when a prepaid card is reloaded. Additionally, the aggregated balance lending account increases by an initial load balance when a customer purchases a merchant branded prepaid card and a prepaid account is created at the sponsor bank for the customer.

Another aspect of the present disclosure relates to a method for transferring a portion of a prepaid account to a transferee, thereby increasing the balance of an aggregated balance lending account that may be used to close or restructure a loan. The method includes receiving a transfer notification from a customer. The transfer notification indicates a transfer amount. The customer is one that previously purchased a merchant branded prepaid card. The merchant branded prepaid card is affiliated with a customer prepaid account, and the customer prepaid account is affiliated with a merchant aggregated balance lending account. Moreover, the method includes requested a transferee prepaid account be created by a sponsor bank. The transferee prepaid account initial balance equals the transfer amount. Further, the transferee prepaid account is affiliated with the merchant aggregated balance lending account.

The method may further include issuing a merchant branded prepaid card, which is affiliated with the transferee prepaid account, to the transferee. The merchant aggregated balance lending account is opened with a distinct merchant lending account when a loan is originated for the merchant. Additionally, the merchant aggregated balance lending account's balance is dependent upon an aggregate balance of prepaid accounts affiliated with merchant branded prepaid cards. Moreover, the method may include conducting underwriting processes on the transferee. The method may also include requested the customer prepaid account be debited by the transfer amount.

A further aspect of the present disclosure relates to a system for allowing a merchant to utilize an aggregated balance lending account, which is dependent upon prepaid card account balances, to close or restructure a loan. The system includes a merchant that requested a loan and a lender that underwrites the requested loan. The system also includes a sponsor bank that creates a merchant lending account and an aggregated balance lending account for the merchant. The aggregated balance lending account has a balance equal to a sum of all prepaid accounts affiliated with merchant branded prepaid cards. The sponsor bank further creates an accumulated aggregate balance account that is accessible by the lender for origination of loans to merchants. The accumulated aggregated balance account has a balance equal to a sum of all merchant aggregated balance lending account affiliated with the lender.

The sponsor bank may also create prepaid account for a customer that purchased a merchant branded prepaid card, and may further create a prepaid account for a transferee to receive a portion of the customer prepaid account funds. The lender may request the sponsor bank to debit the customer prepaid account by a transfer amount and credit the transfer amount to the transferee prepaid account. Moreover, the customer and transferee prepaid accounts may be FDIC insured accounts. The customer and transferee prepaid accounts are each affiliated with merchant branded prepaid cards, and are each affiliated with the aggregated balance lending account of the merchant, which is usable to close or restructure a loan. The funds loaded to the customer and transferee prepaid accounts are credited to the aggregated balance lending account of the merchant in parallel. Additionally, the merchant branded prepaid cards are redeemable at a merchant point of sale.

### BRIEF DESCRIPTION OF THE DRAWINGS

Specific embodiments of the disclosure will become apparent and its construction and operation better understood, from the following detailed description when read in conjunction with the accompanying drawings, in which:

FIG. 1 illustrates a system for originating a loan according to the present disclosure;

FIG. 2 illustrates a system for increasing a merchant aggregated balance lending account balance according to the present disclosure;

FIG. 3 illustrates a system for transferring value of a customer prepaid account to a transferee prepaid account to increase a merchant aggregated balance lending account balance according to the present disclosure;

FIG. 4 illustrates a method for allowing a merchant to utilize an aggregated balance lending account, dependent upon prepaid card account balances, to close or restructure a loan; and

FIG. 5 illustrates a method for transferring a portion of a prepaid account to a transferee to increase the balance of an aggregated balance lending account that may be used by an affiliated merchant to close or restructure a loan.

### DETAILED DESCRIPTION

The present disclosure provides methods and systems for lending money, in which a merchant, e.g., a small or medium sized merchant, has instantaneous access to short-term working capital from float money generated out of a volume of prepaid/gift cards sold to the merchant's customers. For example, the merchant may be a Tier II or Tier III merchant. The lending program described herein provides the ability for a merchant to issue and process virtual prepaid/gift cards, and to receive immediate working cash for business needs as a short-term loan. For example, the business needs may be payroll requirements, infrastructure improvements, or assistance to pay bills due.

When the merchant takes out a short-term loan from a lender, both a Merchant Lending Account (“MLA”), and an Aggregated Balance Lending Account (“ABLA”) are opened. The MLA is the loan account and the ABLA is an account having float accumulation due to prepaid account balances. Put another way, the balance of each prepaid account affiliated with a merchant branded prepaid/gift card is aggregated into the ABLA. Thus, the balance of the ABLA is dictated by loading and redemption of the prepaid accounts. When the value of the ABLA reaches a certain threshold value, the merchant has the option to close or restructure the original loan affiliated with the MLA utilizing ABLA funds.

Moreover, the present disclosure provides an Accumulated Aggregate Balance Account (“AABL”) comprised of surplus float from all ABLAs. Merchants with qualifying ABLAs may apply for loans from the AABL.

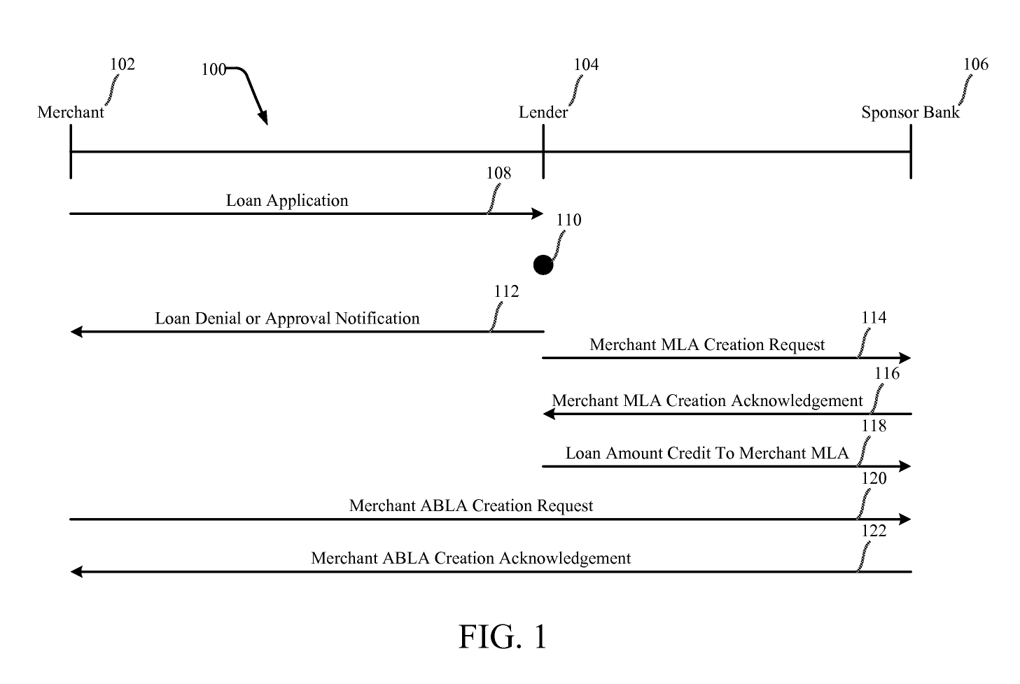

FIG. 1 illustrates a general overview system 100 for providing loans to merchants. The system 100 includes a merchant 102, a lender 104, and a sponsor bank 106.

The merchant 102 fills out a loan application and, upon completion, communicates the loan application to the lender 104 (illustrated as 108). The lender 104 performs an underwriting process to determine whether the requested loan should be originated for the merchant 102 (illustrated as 110). This underwriting process may be faster than a conventional loan underwriting process. Furthermore, in conducting the underwriting of the loan, the lender 104 performs a credit check, an Office of Foreign Assets Control (“OFAC”) check, and/or other checks needed to adequately determine whether the merchant 102 should be approved for the loan. The lender 104 thereby transmits a notification to the merchant 102 evidencing whether the merchant 102 is approved for the requested loan (illustrated as 112).

If the merchant 102 is approved, the lender 104 transmits, to the sponsor bank 106, a request for a Merchant Lending Account (“MLA”) to be created (illustrated as 114). The MLA is an account containing an outstanding repayment balance for the loan. Upon the MLA being created, the sponsor bank 108 transmits a creation acknowledgement to the lender 104 (illustrated as 116). Thereby, the lender 104 transmits, to the sponsor bank 106, a credit for the outstanding loan amount to be input into the MLA (illustrated as 118). As illustrated, the account creation request (illustrated as 114) and the loan amount credit (illustrated as 118) are distinct transmissions from the lender 104 to the sponsor bank 106. However, one skilled in the art should appreciate that the loan amount credit may be transmitted along with or as part of the creation request without departing from the scope of the present disclosure.

Additionally, the merchant 102 transmits, to the sponsor bank 106, an Aggregated Balance Lending Account (“ABLA”) creation request (illustrated as 120), and upon creation of such account, the sponsor bank 106 transmits an ABLA creation acknowledgement to the merchant 102 (illustrated as 122). The ABLA is created to accumulate float from prepaid/gift card balances, illustrated in detail below. As illustrated, the merchant 102 sends the ABLA creation request (illustrated as 120) and receives the ABLA creation acknowledgement (illustrated as 122). In this case, the merchant 102 or the sponsor bank 106 may transmit notification of the creation of the ABLA to the lender 104 (not illustrated). To the contrary, it should also be appreciated to one skilled in the art that the lender 104 may send the ABLA creation request and receive the ABLA creation acknowledgement without departing from the scope of the present disclosure. If the lender 104 conducts these activities, the MLA and ABLA creation requests may be transmitted together or separately and the MLA and ABLA creation acknowledgements may be received together or separately.

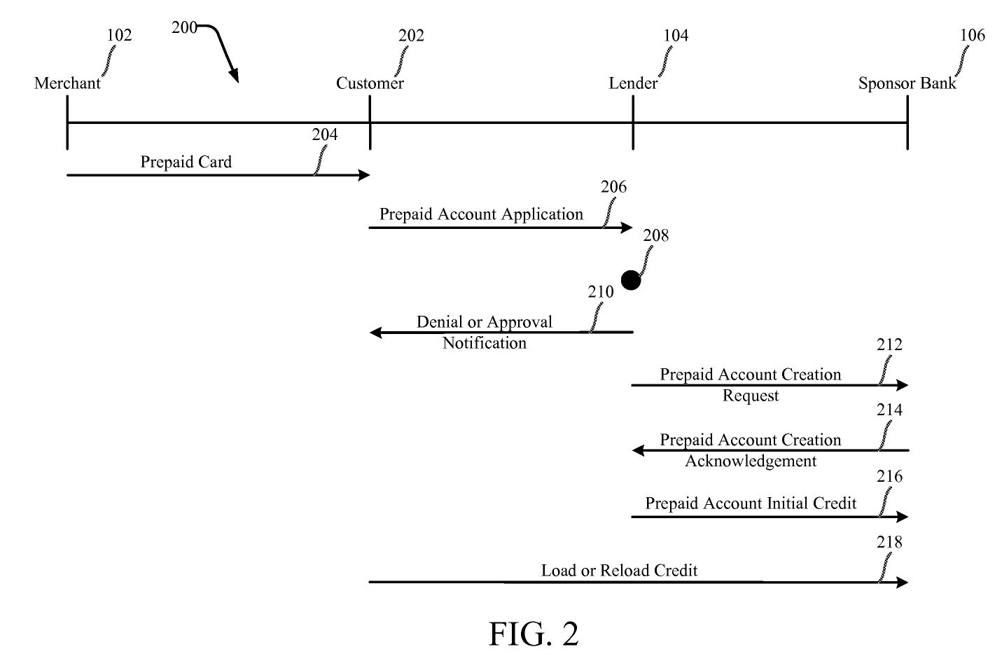

FIG. 2 illustrates a system 200 for increasing the value of an Aggregated Balance Lending Account (“ABLA”). The system 200 includes the merchant 102, a customer 202, the lender 104, and the sponsor bank 106.

The merchant 102 sells a prepaid card to the customer 202 (illustrated as 204). The prepaid card is branded for the merchant, that is the prepaid card is redeemable at the merchant's establishments. The customer 202 thereby signs-up with the lender 104, via a network such as the Internet, to load value/money onto the purchased prepaid card (illustrated as 206). Upon receiving the application from the customer 202, the lender 104 may optionally perform underwriting processes such as a credit check, OFAC check, and/or other checks to ensure risk mitigation (illustrated as 208). If the underwriting process is performed, the lender 104 thereby transmits a notification to the customer 202 evidencing whether the customer 202 is approved (illustrated as 210).

The lender 104 also transmits a prepaid account creation request to the sponsor bank 106 (illustrated as 212). The request identifies the customer 202 and the type of account to be created. For example, the type of account may be an FDIC insured account. Upon creation of the requested account, the sponsor bank 106 transmits a prepaid account creation acknowledgement to the lender 104 (illustrated as 214). The prepaid account is affiliated with the ABLA of the merchant branded card.

Furthermore, the lender 104 transmits a prepaid account initial credit to the sponsor bank 106 (illustrated as 216). This initial credit may be an amount designated at the time the customer 202 purchases the prepaid card from the merchant 102, or may be designated by the customer 202 at some other time, such as when the customer 202 fills out the prepaid account application (illustrated as 206). While it is illustrated that the prepaid account creation request (illustrated as 212) and the prepaid account initial credit (illustrated as 216) are two separate transmissions between the lender 104 and the sponsor bank 106, one skilled in the art should appreciate that the creation request may be accompanied by or may include the initial credit amount without departing from the scope of the present disclosure.

At the customer's volition, the customer 202 loads or reloads value into the prepaid account (illustrated as 218). This amount may be deducted from a bank account or paypal account of the customer 202 affiliated with either the sponsor bank 106 or a third party financial institution, for example. The amount initially loaded (illustrated as 216) and the subsequently reloaded amounts (illustrated as 218) credited to the prepaid account are contributed in parallel to the ABLA of the merchant 102 (described in detail with respect to FIG. 1 above) affiliated with the prepaid card, thereby producing increased float within the ABLA to be used to close or restructure the loan.

The concepts illustrated with respect to FIG. 2, for example, a customer purchasing a prepaid card, the opening of a prepaid account for the customer, and the parallel contribution of the loaded or reloaded amount into the ABLA of the merchant may occur on an n customer basis. Thus, the float money attributable to the ABLA of the merchant fluctuates as prepaid cards with the merchant's branding are redeemed and loaded/reloaded.

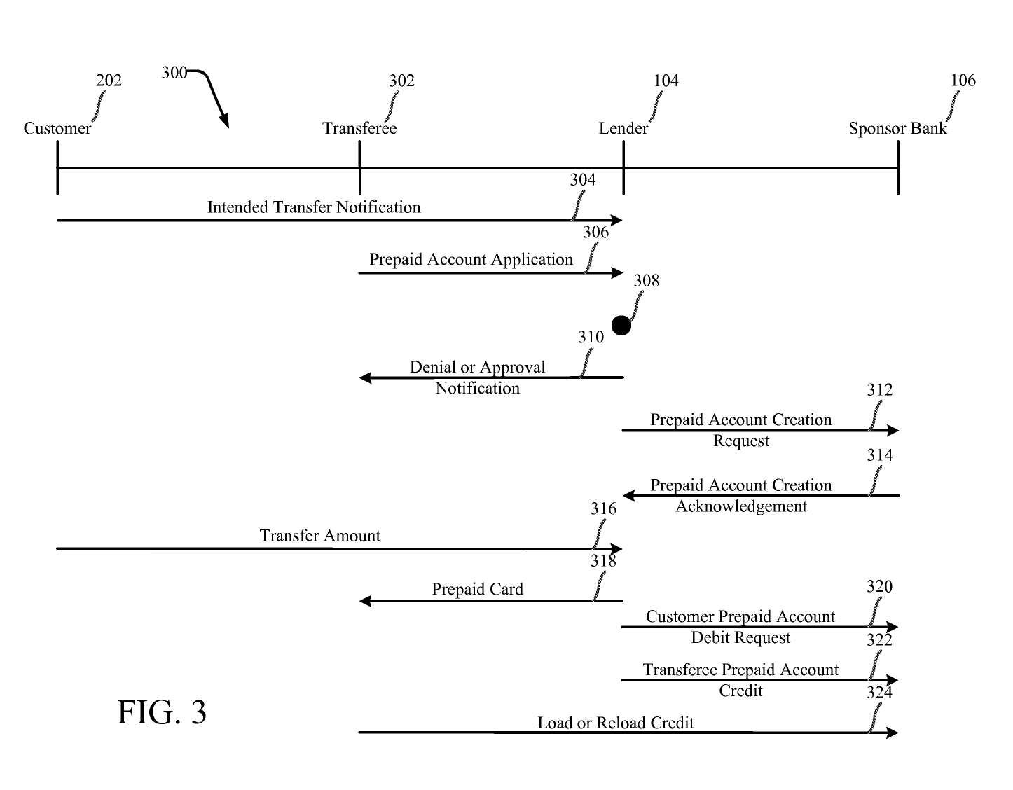

FIG. 3 illustrates a system 300 wherein a portion or all of the balance of a customer prepaid account is transferred to a transferee prepaid account that is creditable to increase ABLA. For illustration, a non-limiting list of potential transferees includes friends and family members. The system 300 includes the customer 202, a transferee 302, the lender 104, and the sponsor bank 106. Furthermore, while it is described with respect to FIG. 3 that the transfer occurs from a customer who purchased the prepaid card to a transferee, one skilled in the art should appreciate that the aspects of the present disclosure described with respect to FIG. 3 may occur between a transferee and a subsequent transferee without departing from the scope of the present disclosure.

The customer 202 initiates the transfer process by notifying the lender 104 of an intended transfer, i.e., the customer's intent to have a prepaid card issued to the transferee that contains a portion or all of an amount of the customer's prepaid account (illustrated as 304). The transferee 302 also submits a prepaid account application to the lender 104 via a network such as the Internet (illustrated as 306). Upon receiving the application from the transferee 302, the lender 104 may optionally perform underwriting processes such as a credit check, OFAC check, and/or other checks to ensure risk mitigation (illustrated as 308). If the underwriting process is performed, the lender 104 thereby transmits a notification to the transferee 302 evidencing whether the transferee 302 is approved (illustrated as 310). If the transferee 302 is approved, the lender 104 transmits a prepaid account creation request to the sponsor bank 106 (illustrated as 312). The request identifies the transferee 302 and the type of account to be created. For example, the type of account may be an FDIC insured account. Upon creation of the requested account, the sponsor bank 106 transmits a prepaid account creation acknowledgement to the lender 104 (illustrated as 314).

The customer 202 also instructs the lender 104 of the amount to be transferred from the customer's prepaid account to the transferee's prepaid account (illustrated as 316). While this amount designation is illustrated as a distinct step, one skilled in the art should appreciate that the amount designation may occur at any time convenient for the customer 202 and or the lender 104. For example, the designation may be conveyed at the same time or as part of the intended transfer notification.

The lender 104 issues the transferee 302 a prepaid card branded for the merchant 102 affiliated with the prepaid card originally sold to the customer 202 (illustrated as 318). Moreover, the lender 104 transmits a debit request to the sponsor bank 106 that indicates the designated transfer amount that should be debited from the customer's prepaid account (illustrated as 320). The lender 104 also transmits a credit to the sponsor bank 106 that indicates the designated transfer amount that should be credited to the transferee's prepaid account (illustrated as 322). While it is illustrated that the debit request (illustrated as 320) and the credit (illustrated as 322) are distinct transmissions, one skilled in the art should appreciate that they may be sent simultaneously or as one transmission without departing from the scope of the present disclosure.

At the transferee's volition, the transferee 302 loads or reloads money into their prepaid account (illustrated as 324). This amount may be deducted from a bank account or paypal account of the transferee 302 affiliated with either the sponsor bank 106 or a third party financial institution, for example. The amount initially loaded into and the subsequently reloaded amounts credited to the transferee's prepaid account are contributed in parallel to the ABLA of the merchant 102 (described in detail with respect to FIG. 1 above) affiliated with the prepaid card sold to the customer 202, thereby producing more float money within the ABLA of the merchant 102.

The concepts illustrated with respect to FIG. 3, for example, the creation of a transferee prepaid account and the transfer of value from an existing prepaid account into the transferee's prepaid account may occur on an n transferee basis.

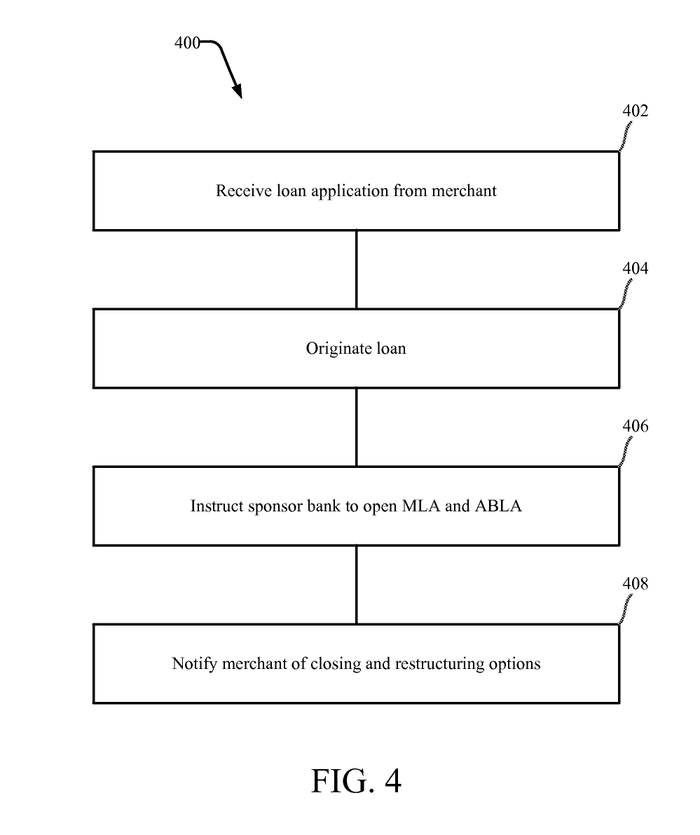

FIG. 4 illustrates a method 400 for allowing a merchant to utilize an aggregated balance lending account, dependent upon prepaid card account balances, to close or restructure a loan. A lender receives a short-term loan application from a merchant (illustrated as 402). The lender also originates the loan by conducting underwriting processes (illustrated as 404). If the merchant is approved for the loan, the lender instructs a sponsor bank to open a merchant lending account (“MLA”) and an aggregated balance lending account for the merchant (“ABLA”) (illustrated as 406). The MLA has a balance equal to an outstanding loan repayment balance. The ABLA has a balance that is continuously equal to a sum of all prepaid account balances affiliated with merchant branded prepaid cards. The merchant branded prepaid cards may be purchased from anywhere. Continual updating of the ABLA may occur on any timeframe such as, for example, hourly, daily, weekly, monthly, yearly, and the like. The ABLA balance decreases when a prepaid card is redeemed and increases when a prepaid card is reloaded. Additionally, the ABLA balance increases by an initial load balance when a customer purchases a merchant branded prepaid card and a prepaid account is created at the sponsor bank. Moreover, the lender notifies the merchant of closing and restructuring options when the aggregated balance lending account reaches a threshold (illustrated as 408). This threshold may be a certain percentage of the MLA such as, for example, 50%, 75%, 100%, and the like.

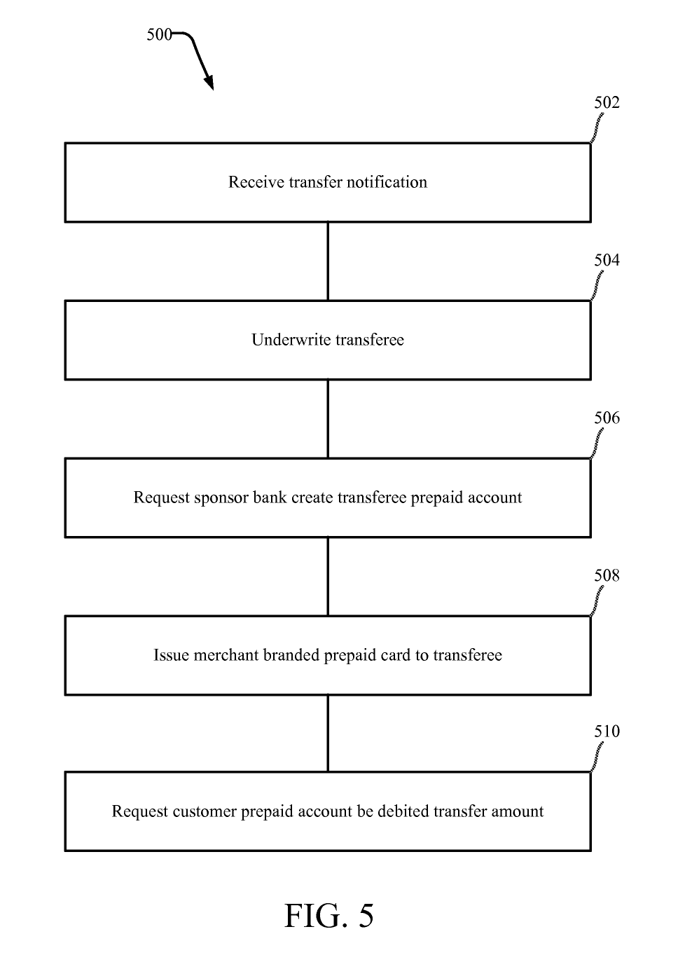

FIG. 5 illustrates a method 500 for transferring a portion of a prepaid account to a transferee to increase the balance of an aggregated balance lending account that may be used to close or restructure a loan. A lender receives a transfer notification, indicating a transfer amount, from a customer that has purchased a merchant branded prepaid card (illustrated as 502). The prepaid card is affiliated with a customer prepaid account, and the customer prepaid account is affiliated with a merchant aggregated balance lending account (“ABLA”). The ABLA is opened along with a merchant lending account (“MLA”) when a loan is originated for the merchant. Further, the ABLA continuously has a balance dependent upon an aggregate balance of prepaid account affiliated with merchant branded prepaid cards. The ABLA balance may be updated secondly, minutely, hourly, daily, monthly, yearly, and the like. The lender also conducts underwriting processes on the transferee to mitigate risk of default (illustrated as 504). If the transferee meets desired underwriting standards, the lender requests a sponsor bank create a transferee prepaid account (illustrated as 506). The transferee prepaid account has an initial balance equaling the transfer amount. Moreover, the transferee prepaid account is affiliated with the ABLA. The lender may also issue a merchant branded prepaid card to the transferee (illustrated as 508). The issued prepaid card is affiliated with the transferee prepaid account. Additionally, the lender may request the sponsor bank debit the customer prepaid account by the transfer amount (illustrated as 510).

It is understood that aspects of the present disclosure described herein can be implemented by computer program instructions. These computer program instructions may be provided to a processor of a computer and/or other programmable data processing apparatus to produce a machine, such that the instructions, which execute via the processor of the computer and/or other programmable data processing apparatus, create means (functionality) and/or structure for implementing the functions/acts specified herein.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified herein.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified herein.

Accordingly, certain embodiments may be embodied in hardware and/or in software (including firmware, resident software, micro-code, etc.). Furthermore, certain embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted herein may occur out of the order noted herein.

Furthermore, it will be appreciated that while embodiments of the disclosure have been described in connection with cards, no physical “card” is necessary for the implementation of the disclosure. Accordingly, embodiments may be used in connection with any financial ledger account or payment system that is identified by a unique account number or cryptocurrency, including, for example, merchant accounts, debit accounts, bitcoins, revolving card accounts, retail card accounts, and the like.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

Although specific components have been set forth, it will be appreciated by those skilled in the art that not all of the disclosed components are required to practice the disclosed configurations. Moreover, certain well known components have not be described, to maintain focus on the disclosure.

In the drawings and specification, there have been disclosed embodiments of the disclosure and, although specific terms are employed, they are used in a generic and descriptive sense only and not for purposes of limitation, the scope of the disclosure being set forth in the following claims.

What is claimed is:

1. A method for allowing a merchant to utilize an aggregated balance lending account, dependent upon prepaid card account balances, to close or restructure a loan, comprising the steps of:
receiving a short-term loan application from a merchant;
originating the loan by conducting underwriting processes;
instructing a sponsor bank to open a merchant lending account and an aggregated balance lending account, the aggregated balance lending account having a balance equal to a sum of all prepaid account balances affiliated with merchant branded prepaid cards; and
notifying the merchant of closing and restructuring options when the aggregated balance lending account reaches a threshold.

2. The method of claim 1, wherein the merchant lending account has a balance equal to an outstanding loan repayment amount.

3. The method of claim 1, wherein the aggregated balance lending account decreases when a prepaid card is redeemed.

4. The method of claim 1, wherein the aggregated balance lending account increases when a prepaid card is reloaded.

5. The method of claim 1, wherein the aggregated balance lending account increases by an initial load balance when a customer purchases a merchant branded prepaid card and a prepaid account is created at the sponsor bank for the customer.

6. A method for transferring a portion of a prepaid account to a transferee to increase the balance of an aggregated balance lending account that may be used to close or restructure a loan, comprising the steps of:
receiving a transfer notification from a customer, the transfer notification indicating a transfer amount, the customer having purchased a merchant branded prepaid card affiliated with a customer prepaid account, the customer prepaid account being affiliated with a merchant aggregated balance lending account; and
requesting a transferee prepaid account be created by a sponsor bank, the transferee prepaid account initial balance equaling the transfer amount, the transferee prepaid account being affiliated with the merchant aggregated balance lending account.

7. The method of claim 6, further comprising the step of:
issuing a merchant branded prepaid card to the transferee, the prepaid card being affiliated with the transferee prepaid account.

8. The method of claim 6, wherein the merchant aggregated balance lending account is opened along with a merchant lending account when a loan is originated.

9. The method of claim 6, wherein the merchant aggregated balance lending account has a balance dependent upon an aggregate balance of prepaid accounts affiliated with merchant branded prepaid cards.

10. The method of claim 6, further comprising the step of:
conducting underwriting processes on the transferee.

11. The method of claim 6, further comprising the step of:
requesting the customer prepaid account be debited by the transfer amount.

12. A system for allowing a merchant to utilize an aggregated balance lending account, dependent upon prepaid card account balances, to close or restructure a loan, comprising:
a merchant that requests a loan;
a lender that underwrites the requested loan; and
a sponsor bank that creates a merchant lending account and an aggregated balance lending account for the merchant, the aggregated balance lending account having a balance equal to a sum of all prepaid accounts affiliated with merchant branded prepaid cards, the sponsor bank further creating an accumulated aggregate balance account, the accumulated aggregate balance account being accessible by the lender for origination of loans to merchants, the accumulated aggregate balance account having a balance equal to a sum of all merchant aggregated balance lending accounts affiliated with the lender.

13. The system of claim 12, wherein the sponsor bank creates a prepaid account for a customer that purchased a merchant branded prepaid card.

14. The system of claim 13, wherein the sponsor bank creates a prepaid account for a transferee.

15. The system of claim 14, wherein the lender requests the sponsor bank to debit the customer prepaid account by a transfer amount and the lender further requests the sponsor bank to credit the transfer amount to the transferee prepaid account.

16. The system of claim 14, wherein the customer prepaid account and the transferee prepaid account are FDIC insured accounts.

17. The system of claim 14, wherein the customer prepaid account and the transferee prepaid account are each affiliated with merchant branded prepaid cards.

18. The system of claim 14, wherein the customer prepaid account and the transferee prepaid account are each affiliated with the aggregated balance lending account of the merchant.

19. The system of claim 14, wherein funds loaded to the customer prepaid account and the transferee prepaid account are credited to the aggregated balance lending account of the merchant in parallel.

20. The system of claim 12, wherein the merchant lending account and the aggregated balance lending account have balances measured in bitcoins.
